(19) United States
(12) Patent Application Publication
(10) Pub. No.: US 2024/0228819 A1
(43) Pub. Date: Jul. 11, 2024

(54) WATER-BORNE COATING COMPOSITION, ITS PREPARATION METHOD AND APPLICATION THEREOF

(71) Applicant: BASF COATINGS GMBH, Muenster (DE)

(72) Inventors: Ming WANG, Shanghai (CN); Xiao Gang YOU, Shanghai (CN); Ranjit SALVI, Shanghai (CN); Yuan Yuan SONG, Shanghai (CN); Ling Yu SUI, Shanghai (CN); Qin Yuan CHEN, Shanghai (CN); Wen Wen TAN, Shanghai (CN); Han Bin WANG, Singapore (SG)

(21) Appl. No.: 18/559,917

(22) PCT Filed: Jun. 3, 2022
(86) PCT No.: PCT/EP22/65158

§ 371 Date: Nov. 9, 2023

(30) Foreign Application Priority Data
Jun. 7, 2021 (WO) PCT/CN2021/098610

(51) Int. Cl. C09D 133/10; C09D 7/65; C09D 7/80

(52) U.S. Cl. CPC C09D 133/10; C09D 7/65; C09D 7/80

(57) ABSTRACT

Disclosed herein is a water-borne coating composition including a) at least one water-soluble or water-dispersable binder, and b) at least one sagging control agent (SCA) that is obtained by reaction of b1) at least one aliphatic polyisocyanate and b2) at least one amine selected from a group consisting of C₁-C₁₀-alkoxy-C₁-C₁₀-alkylamine, di-C₁-C₁₀-alkoxy-C₁-C₁₀-alkylamine, C₄-C₁₀-alkyl substituted aniline and di-C₄-C₁₀-alkyl substituted aniline in the presence of Component a). Further disclosed herein is a method of preparing the coating composition.

### TECHNICAL FIELD

The present invention relates to a water-borne coating composition, more specifically a water-borne coating composition for automotive finishing and refinishing. This invention also relates to a preparation method of said coating composition.

### BACKGROUND

One critical requirement for automotive coatings is well spreading during applying but not dripping from surfaces of substrates later on. In another word, the viscosity of coatings shall be kept at a proper range during applying onto the surfaces of substrates so that the formed coating layer could be smooth and uniform. But thereafter the viscosity of the coating shall increase to prevent dripping from vertical surfaces of substrates.

To meet such requirement, rheological additives such as Sagging Control Agents (SCAs) are added to the coatings. The function of SCA is anti-setting and most of SCAs are semi-crystalline ureido-containing organic compounds having low molecular weights. Those SCAs are particularly useful in solvent-borne coating compositions having middle to high solid contents.

In another side, water-borne coatings become popular in recent years due to increasingly strict regulations on environment protection. The water-borne coatings also need SCAs. However, the commonly used SCAs tend to increase the content of organic solvents and may not be suitable for water-borne coatings.

Therefore, it is still required to prepare water-borne coatings having improved rheological properties enabled by proper SCAs.

### SUMMARY OF THE INVENTION

In one aspect, the present invention provides a water-borne coating composition, comprising
a) at least one water-soluble or water-dispersable binder,
b) at least one sagging control agent (SCA),
wherein Component b) is obtained by reaction of
b1) at least one aliphatic polyisocyanate, and
b2) at least one amine selected from a group consisting of C₁-C₁₀-alkoxy-C₁-C₁₀-alkylamine, di-C₁-C₁₀-alkoxy-C₁-C₁₀-alkylamine, C₄-C₁₀-alkyl substituted aniline and di-C₄-C₁₀-alkyl substituted aniline in the presence of Component a).

In another aspect, the present invention provides a method of preparing the invented water-borne coating composition by mixing all components.

In a further aspect, the present invention provides a coating layer formed by curing the invented water-borne coating composition that is applied onto a substrate.

It is surprising to find the invented water-borne coating composition has significantly improved rheological properties.

### DETAILED DESCRIPTION OF THE INVENTION

Unless defined otherwise, all technical and scientific terms used herein have the same meaning as commonly understood by one of ordinary skill in the art to which this invention belongs.

Expressions “a”, “an”, “the”, when used to define a term, include both the plural and singular forms of the term.

All percentages, parts and ratios are by weight, unless otherwise specified.

Water-borne dispersion shall be used as synonym for the group consisting of water-borne solution and water-borne emulsion.

### Component a)

Component a) of the invented water-borne coating composition comprises at least one water-soluble or water-dispersable binder and said binder may have functional groups reactive to crosslinking agents.

The water-soluble or water-dispersable binder commonly used to prepare the water-borne coating compositions can be used as binder component a). Those water-soluble or water-dispersable binders as well as their preparation methods are known to persons skilled in the art.

Examples of water-soluble or water-dispersable binders include but are not limited to polyacrylate resins, polyester resins, melamine resins, polyethers and polyurethane resins that could be dissolved or dispersed in water.

Water-soluble or water-dispersable polyacrylate resins are polymers and/or copolymers of (meth)acrylate. In some embodiments, the (meth)acrylate polymer and/or copolymer is a polymeric organic compound synthesized from (meth)acrylate excluding hydroxyl functionality, (meth)acrylate having at least one hydroxyl functionality, and optionally (meth)acrylic acid as well as other monomers having at least one olefinic double bond. The term (meth)acrylate means acrylates and/or methacrylates. The term (meth)acrylic acid means acrylic acid and/or methacrylic acid.

Examples of said (meth)acrylate monomers excluding hydroxyl functionality include but are not limited to alkyl (meth)acrylates and cycloalkyl (meth)acrylates such as C₁-C₁₈-alkyl (meth)acrylates and C₃-C₈-cycloalkyl (meth)acrylates, preferably C₁-C₁₂-alkyl (meth)acrylates and C₃-C₆-cycloalkyl (meth)acrylates, and more preferably C₁-C₆-alkyl (meth)acrylates and C₅-C₆-cycloalkyl (meth)acrylates. In some embodiments, said alkyl (meth)acrylates excluding hydroxyl functionality is at least one selected from a group consisting of ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate, lauryl methacrylate, tridecyl acrylate and tridecyl methacrylate, and preferably from a group consisting of methyl acrylate, methyl methacrylate, ethyl acrylate, ethyl methacrylate, propyl acrylate, propyl methacrylate, butyl acrylate, butyl methacrylate, ethylhexyl acrylate, ethylhexyl methacrylate, tridecyl acrylate and tridecyl methacrylate. In some embodiments, said cycloalkyl (meth)acrylates excluding hydroxyl functionality is at least one selected from a group consisting of cyclopentyl acrylate, cyclopentyl methacrylate, isobornyl acrylate, isobornyl methacrylate, cyclohexyl acrylate and cyclohexyl methacrylate, and preferably from a group consisting of cyclohexyl acrylate and cyclohexyl methacrylate.

Examples of said (meth)acrylate monomers having at least one hydroxyl functionality include but are not limited to hydroxyalkyl (meth)acrylates, preferably C₁-C₆-hydroxyalkyl (meth)acrylates, and more preferably C₂-C₄-hydroxyalkyl (meth)acrylates. In some embodiments, said hydroxyalkyl (meth)acrylates having at least one hydroxyl functionality is at least one selected from a group consisting of 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, and preferably from a group consisting of 2-hydroxyethyl acrylate and 2-hydroxyethyl methacrylate.

The polyacrylate resins may optionally comprise, in a form of monomeric units, acrylic acid, methacrylic acid or any combinations thereof as comonomers. In this situation, the polyacrylate resins may comprise free carboxylic acid, preferably acrylic acid.

The polyacrylate resins may optionally comprise, in a form of monomeric units, monomers having at least one olefinic double bond. Examples of these monomers include but are not limited to vinylaromatic hydrocarbons. In some embodiments, said monomer is at least one selected from a group consisting of styrene, vinyltoluene, alpha-methylstyrene, amide or nitrile of (meth)acrylic acid, vinyl ester and vinyl ether, and preferably from a group consisting of styrene, amide or nitrile of (meth)acrylic acid, vinyl esters and vinyl ethers.

No special limitation exists for the molecular weight of said polyacrylate resins. Preferably, the number-average molecular weight of said polyacrylate resins is from 1,000 to 10,000 g/mol, and more preferably from 1,500 to 5,000 g/mol. Alternatively, the weight-average molecular weight of said polyacrylate resins is preferably from 3,000 to 20,000 g/mol, and more preferably from 5,000 to 12,000 g/mol.

In some embodiments, said polyacrylate resins may have an acid value of from 10 to 200 mg KOH/g, preferably from 20 to 100 mg KOH/g, and more preferably from 30 to 50 mg KOH/g.

In some embodiments, said polyacrylate resins may have a hydroxyl value of from 50 to 300 mg KOH/g, preferably from 60 to 240 mg KOH/g, and more preferably from 80 to 200 mg KOH/g.

Besides commercially available polyacrylate resins, it is also possible to use prepared (meth)acrylate (co)polymers. The preparation methods of said (meth)acrylate (co)polymers are known to persons skilled in the art, for example, continuous or batchwise, free-radically initiated (co)polymerization in bulk, solution, emulsion or microemulsion under atmospheric or high pressure and in stainless steel reactors, stirred tanks, autoclaves, tube reactors, loop reactors or Taylor reactors at a temperatures of from 50° C. to 200° C., preferably from 80° C. to 180° C., and more preferably from 100° C. to 150° C. Examples of initiators for free-radical (co)polymerization is at least one selected from a group consisting of dialkyl peroxides such as di-tert-butyl peroxide or dicumyl peroxide, hydroperoxides such as cumene hydroperoxide or tert-butyl hydroperoxide, or peroxyesters such as tert-butyl peroxybenzoate, tert-butyl peroxypivalate, tert-butyl peroxy-3,5,5-trimethylhexanoate or tert-butyl peroxy-2-ethylhexanoate, peroxodicarbonates, potassium, sodium or ammonium peroxodisulfate, azo initiators such as azobisisobutyronitrile, or C-C-cleaving initiators such as benzpinacol silyl ethers.

Water-soluble or water-dispersable polyester resins are known to persons skilled in the art and can be prepared by reacting polyhydric alcohols and polycarboxylic acids or anhydrides.

Preferably, said polyester resins have an average condensation degree of from 10 to 25. The condensation degree means the number of repetitive units in polyester resin that are obtained from condensation reactions.

Preferably, said polyester resins have a maximum acid value of 30 and a maximum hydroxyl value of 150.

Said acid components for synthesis of the polyester resins are saturated or unsaturated aliphatic and/or cycloaliphatic and/or aromatic polybasic carboxylic acids, preferably di-, tri- and tetracarboxylic acids having 2 to 14 and more preferably 4 to 12 carbon atoms or their derivatives capable of esterification (for example anhydrides or esters). Examples include but are not limited to phthalic anhydride, isophthalic acid, terephthalic acid, tetrahydro- and hexahydrophthalic anhydride, endomethylenetetrahydrophthalic acid, succinic acid, glutaric acid, sebacic acid, azelaic acid, trimellitic acid, trimellitic anhydride, pyromellitic anhydride, fumaric acid and maleic acid. Phthalic anhydride is the most widely used acid component. The polyester resin should contain fumaric and maleic acid radicals in an amount of no more than 20% by molar based on the total number of polycarboxylic acid radicals for condensation.

Said polyhydric alcohols for synthesis of the polyesters resins are aliphatic and/or cycloaliphatic and/or araliphatic alcohols having 1 to 15 and preferably 2 to 6 carbon atoms and 1 to 6 and preferably 1 to 4 hydroxyl groups connected to non-aromatic carbon atoms, for example glycols such as ethylene glycol, propane-1,2- and propane-1,3-diol, butane-1,2-, -1,3- and -1,4-diol, 2-ethylpropane-1,3-diol, 2-ethylhexane-1,3-diol, neopentyl glycol, 2,2-trimethylpentane-1,3-diol, hexane-1,6-diol, cyclohexane-1,2- and -1,4-diol, 1,2- and 1,4-bis(hydroxymethyl)cyclohexane, bis(ethylene glycol) adipate; ether alcohols such as diethylene and triethylene glycol, dipropylene glycol; dimethylolpropionic acid, oxalkylated bisphenols having two C₂-C₃-hydroxyalkyl groups, perhydrogenated bisphenols; butane-1,2,4-triol, hexane-1,2,6-triol, trimethylolethane, trimethylolpropane, trimethylolhexane, glycerol, pentaerythritol, dipentaerythritol, mannitol and sorbitol; chain-terminating monohydric alcohols having 1 to 8 carbon atoms such as propanol, butanol, cyclohexanol and benzyl alcohol, hydroxypivalic acid. The most widely used alcohols are glycerol, trimethylolpropane, neopentyl glycol and pentaerythritol.

The polyester resins may also be modified by monocarboxylic acid and monohydric alcohols.

Examples of monocarboxylic acids are saturated or unsaturated fatty acids, benzoic acid, p-tert-butylbenzoic acid, hexahydrobenzoic acid and abletic acid.

Examples of monohydric alcohols are methanol, propanol, cyclohexanol, 2-ethylhexanol and benzyl alcohol.

It is also possible to replace no more than 25% by molar of ester bonds by urethane bonds.

Water-soluble or water-dispersable melamine resins are known to persons skilled in the art. Said melamine resins are etherified melamine/formaldehyde. Besides condensation degree, the water-solubility of said melamine resins depends on the etherification components. Melamine resins are preferably melamine etherified with methanol. If solubilizers are added, melamine etherified with butanol may be dispersed in water.

Examples of water-soluble or water-dispersable polyethers are linear or branched poly(oxyalkylene) glycols, preferably linear or branched poly(oxypropylene) glycols with a weight-average molecular weight of from 400 to 1,000, preferably from 600 to 900.

Preferably, said water-soluble or water-dispersable polyurethane resins are the polyurethane resins disclosed in German Offenlegungsschrift 3,545,618 and U.S. Pat. No. 4,423,179.

The water-soluble or water-dispersable binders may comprise reactive or non-reactive resins. The binders may be hardening by solvent evaporation, crosslinking via embedded functional groups or by added crosslinking agent. Crosslinking may occur for example, by ionic and/or radical polymerisation, polycondensation and/or polyaddition reactions. Groups in binders for crosslinking are, for example, hydroxyl, blocked hydroxyl groups, blocked isocyanate groups, acetoacetyl groups, (meth)acryloyl groups, allyl groups, epoxide groups, carboxyl groups, carbamate amine groups and blocked amine groups.

To reach sufficient water solubility, the binders can be modified to be more hydrophilic. The binders may be ionically (anionically and/or cationically) or non-ionically modified. And an anionic or non-ionic modification is preferred. An anionic modification may be achieved, for example, by incorporating carboxyl groups or sulfonic acid groups which are at least partially neutralized by bases. Examples of said bases are tertiary amines such as trimethylamine, triethylamine, dimethylethylamine, dimethylbutylamine, N-methylmorpholine, dimethylethanolamine and dimethylisopropanolamine. A non-ionic modification may be achieved, for example, by incorporating polyethylene oxide units. Alternatively or in addition thereto, emulsifiers could be used to increase the hydrophilicity.

### Component b)

The coating composition according to the invention comprises at least one SCA (sagging control agent). The SCA is prepared by reacting at least one aliphatic polyisocyanate b1) with at least one amine b2) selected from the group consisting of C₁-C₁₀-alkoxy-C₁-C₁₀-alkylamine, di-C₁-C₁₀-alkoxy-C₁-C₁₀-alkylamine, C₄-C₁₀-alkyl substituted aniline and di-C₄-C₁₀-alkyl substituted aniline in the presence of Component a).

Any suitable aliphatic polyisocyanate b1) can be used for preparation of SCA. For example, any aliphatic polyisocyanate with NCO functionality of from 2.0 to 5.0 can be used. The polyisocyanates have carbon atoms of from 3 to 40 and preferably from 4 to 20. It is preferred to use symmetrical aliphatic diisocyanates and/or their oligomers, for example symmetrical diisocyanates and/or trimers of symmetrical diisocyanates.

Other examples of diisocyanates include but are not limited to tetramethylene-1,4-diisocyanate, hexamethylene-1,6-diisocyanate, octamethylene diisocyanate, decamethylene diisocyanate, dodecamethylene diisocyanate, tetradecamethylene diisocyanate, trimethylhexane diisocyanate, tetramethylhexane diisocyanate and oligomers of diisocyanates like dimeric and/or trimeric derivatives of diisocyanates, e.g. uretdione, isocyanurate and biuret analogues. The polyisocyanates may also have carbodiimide, allophanate, urethane and urea groups. Preferably SCA comprises the oligomers of hexamethylene-1,6-diisocyanate and more specifically the trimer of hexamethylene-1,6-diisocyanate. Those polyisocyanates can be used alone or in random combinations.

The Component b2) used in the preparation of SCA is at least one selected from a group consisting of C₁-C₁₀-alkoxy-C₁-C₁₀-alkylamine, di-C₁-C₁₀-alkoxy-C₁-C₁₀-alkylamine, C₄-C₁₀-alkyl substituted aniline and di-C₄-C₁₀-alkyl substituted aniline, preferably from a group consisting of C₁-C₆-alkoxy-C₂-C₆-alkylamine, di-C₁-C₆-alkoxy-C₂-C₆-alkylamine, C₄-C₈-alkyl substituted aniline and di-C₄-C₈-alkyl substituted aniline, and more preferably from a group consisting of C₁-C₄-alkoxy-C₂-C₄-alkylamine and C₄-C₆-alkyl substituted aniline.

Examples of C₁-C₁₀-alkyloxy include but are not limited to methoxy, ethoxy, propoxy, isopropoxy, butoxy, sec-butoxy, isobutoxy and tert-butoxy, pentoxy, isopentoxy, hexoxy, heptoxy, octoxy and decyloxy, preferably methoxy, ethoxy, propoxy, isopropoxy, butoxy, sec-butoxy, isobutoxy and tert-butoxy, pentoxy, isopentoxy and hexoxy, and more preferably methoxy, ethoxy, propoxy, isopropoxy, butoxy, sec-butoxy, isobutoxy and tert-butoxy.

Examples of C₁-C₁₀-alkyl include but are not limited to methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethyl-hexyl, 1,1,3,3-tetramethylpentyl, nonyl and decyl and their isomers, preferably ethyl, propyl, isopropyl, n-butyl, sec-butyl, isobutyl, tert-butyl, 2-ethylbutyl, n-pentyl, isopentyl, 1-methylpentyl, 1,3-dimethylbutyl and n-hexyl, and more preferably ethyl, propyl, isopropyl, n-butyl, sec-butyl, isobutyl and tert-butyl.

Examples of C₄-C₁₀-alkyl include but are not limited to n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethyl-hexyl, 1,1,3,3-tetramethylpentyl, nonyl and decyl and their isomers, preferably n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl and 2-ethylhexyl, and more preferably n-butyl, sec-butyl, isobutyl, tert-butyl, 2-ethylbutyl, n-pentyl, isopentyl, 1-methylpentyl, 1,3-dimethylbutyl and n-hexyl.

Preferably, Component b2) is at least one selected from a group consisting of 2-methoxyethylamine, 2-ethoxyethylamine, 3-methoxy-1-propylamine, 1-methoxybutyl-2-amine, 1,1-dimethoxy-2-propylamine, 3-ethoxy-1-propylamine, 3-butoxy-1-propylamine, 3-(2-ethylhexyloxy)-1-propylamine, 4-n-butyl aniline, 4-sec-butyl aniline, 4-isobutyl aniline, 4-tert-butyl aniline, 4-n-pentyl aniline, 4-isopentyl aniline and 4-n-hexyl aniline, more preferably from a group consisting of 3-methoxy-1-propylamine, 3-ethoxy-1-propylamine, 3-butoxy-1-propylamine, 4-n-butyl aniline, 4-sec-butyl aniline, 4-isobutyl aniline and 4-tert-butyl aniline, and even more preferably from a group consisting of 3-methoxy-1-propylamine, 3-ethoxy-1-propylamine, 4-n-butyl aniline, 4-isobutyl aniline and 4-tert-butyl aniline.

To obtain SCA by reaction of Components b1) and b2), the molar ratio of amino groups of amine to isocyanate groups of polyisocyanate is in a range of from 0.7 to 1.5, preferably from 0.8 to 1.2 and more preferably from 0.9 to 1.1. Ideally, such molar ratio is 1:1.

It is essential to prepare the SCA by reacting Components b1) and b2) in aqueous phase in the presence of Component a).

The reaction between Components b1) and b2) may be carried out in the following different ways in the presence of Component a):
Option one: The amine is mixed with the water-soluble or water-dispersable binder and subsequently the polyisocyanate is added to the mixture of amine and binder.
Option two: The polyisocyanate is mixed with the water-soluble or water-dispersable binder and subsequently the amine is added to the mixture of polyisocyanate/binder.
Option three: A mixture of the water-soluble or water-dispersable binder and the amine is mixed with a mixture of the water-soluble and water-dispersable binder and the polyisocyanate.
Option four: The amine and the polyisocyanate are mixed with the water-soluble or water-dispersable dilutable binder simultaneously.

If desired, the addition of polyisocyanate and/or amine may be done in one or more steps. It should be ensured that the polyisocyanate does not react with reactive groups of the binder when selecting option 2 or 3.

Preferably, the reaction temperature is in a range of from 0° C. to 95° C. and more preferred from 10° C. to 40° C.

Although Components b1) and b2) may be combined in any manner, it is preferred polyisocyanate is added to amine, i.e. Component b2) is mixed with Component a) and subsequently Component b2) is added to the mixture of Components b1) and a).

Preferably, the amine is mixed with the water-soluble or water-dispersable binder and after the mixture is homogenized, the polyisocyanate is immediately added to the mixture with stirring.

The SCA has a viscosity in a range of from 1,000 to 22,000 mPa·s, preferably from 1,600 to 20,000 mPa·s, and more preferably from 2,500 to 18,000 mPa·s at a shearing rate of 1 s⁻¹, and in a range of from 200 to 2,000 mPa·s, preferably from 400 to 1,600 mPa·s and more preferably from 500 to 1,400 mPa·s at a shearing rate of 1,000 s⁻¹, as measured by means of a rheometer.

### Component c)

The coating composition according to the invention may optionally comprise at least one crosslinking agent c). The crosslinking agent Component c) includes nonblocked, partially blocked and/or blocked polyisocyanates and also amino resins. Very particular preference is given to the use of nonblocked polyisocyanates. For the purposes of the invention, polyisocyanates as the crosslinking agents are understood to be organic compounds which contain at least two isocyanate groups. In principle it is possible to use all organic compounds that contain at least two isocyanate groups. It is also possible to use reaction products that contain isocyanate groups and are formed from, for example, polyhydric alcohols and polyamines and polyisocyanates.

It is also possible to use aliphatic or cycloaliphatic polyisocyanates, preferably diisocyanates, very preferably aliphatic diisocyanates, but more particularly hexamethylene diisocyanate (HDI), dimeric and/or trimeric hexamethylene diisocyanate.

Further examples of suitable polyisocyanates are isophorone diisocyanate, 2 isocyanatopropylcyclohexyl isocyanate, dicyclohexylmethane 2,4′-diisocyanate or dicyclohexylmethane 4,4′-diisocyanate, diisocyanates derived from dimer fatty acids, of the kind sold by Henkel under the trade name DDI 1410, 1,8-diisocyanato-4-isocyanatomethyloctane, 1,7-diisocyanato-4-isocyanatomethylheptane or 1-iso-cyanato-2-(3-isocyanatopropyl)cyclohexane, or mixtures of these polyisocyanates.

Likewise deserving of mention are, for example, tetramethylene 1,4-diisocyanate, cyclohexyl 1,4-diisocyanate, 1,5-dimethyl-2,4-di(isocyanatomethyl)benzene, 1,5-dimethyl-2,4-di(isocyanatoethyl)benzene, 1,3,5-trimethyl-2,4-di(isocyanatomethyl)benzene, 1,3,5-triethyl-2,4-di(isocyanatomethyl)benzene, dicyclohexyldimethylmethane 4,4′-diisocyanate, 2,4-tolylene diisocyanate, 2,6-tolylene diisocyanate and diphenylmethane 4,4′-diisocyanate.

In an especially preferred embodiment, the trimer of hexamethylene 1,6-diisocyanate is used as the crosslinking agent; this compound is available, for example, as a commercial product under the name Desmodur N3390 (Bayer MaterialScience) or Basonat HI190 (BASF SE).

Further examples of suitable polyisocyanates are organic polyisocyanates, more particularly so-called paint polyisocyanates, having aliphatically, cycloaliphatically, araliphatically and/or aromatically attached free isocyanate groups. Preference is given to using polyisocyanates having 2 to 5 isocyanate groups and having viscosities of 100 to 10,000, preferably 100 to 5,000, and more particularly 100 to 2,000 mPa·s (at 23° C.). Optionally, the polyisocyanates may also be admixed with small amounts of organic solvent, preferably 1% to 25% by weight, based on pure polyisocyanate, in order thus to improve the ease of incorporation of the isocyanate and optionally to lower the viscosity of the polyisocyanate to a level within the abovementioned ranges. Examples of suitable solvent additions to the polyisocyanates include ethoxyethyl propionate, amyl methyl ketone or butyl acetate. Furthermore, the polyisocyanates may have been subjected to conventional hydrophilic or hydrophobic modification.

Polyurethane prepolymers having isocyanate groups could be used as well and can be prepared by reaction of polyhydric alcohols with an excess of polyisocyanates. Other examples of polyisocyanates are those having isocyanurate, biuret, allophanate, iminooxadiazinedione, urethane, urea and/or uretdione groups. Polyisocyanates having urethane groups are obtained by reacting some of the isocyanate groups with polyhydric alcohols, such as trimethylolpropane and glycerol.

Further examples of isocyanates are described in “Methoden der organischen Chemie”, Houben-Weyl, volume 14/2, 4th edition, Georg Thieme Verlag, Stuttgart 1963, pages 61 to 70, W. Siefken, Liebigs Ann. Chem. 562, 75 to 136, European patent EP-A-101 832 or U.S. Pat. Nos. 3,290,350, 4,130,577, and 4,439,616.

The above-mentioned polyisocyanates are present in free form (nonblocked) as crosslinking agents. These free polyisocyanates used in multi-component systems, particularly in two-component systems, are known to persons skilled in the art. For the present invention this means that Component a) and Component c) are stored separately in a case of two-component system and are mixed immediately before application.

Meanwhile, blocked polyisocyanates could be used alternatively. The blocked polyisocyanates are used as crosslinking agents in the context of the invention in a case of one-component system, which means Component a) and Component c) can be stored and applied as a mixture. In contrast to free isocyanates, blocked polyisocyanate as crosslinking agents are able to react only at elevated temperatures with functional groups of binders. Such blocked polyisocyanate as crosslinking agents may also be used in multi-component systems, particularly in two-component systems.

The blocked crosslinking agents are de-blocked at an elevated temperature (approximately 80° C. to 100° C.) and enabled to take reaction with the binders.

Examples of typical blocking agents are phenols, alcohols, oximes, pyrazoles, amines, and CH-acidic compounds such as diethyl malonate. The blocking agents react with free NCO groups of crosslinking agents in the presence of catalysts such as dibutyltin dilaurate or tin(II) bis(2-ethylhexanoate). The blocking agents and the reactions are known to persons skilled in the art and are described in U.S. Pat. No. 4,444,954A. Preferably, the blocking agent is at least one selected from a group consisting of caprolactam, butanone oxime, acetone oxime, diethyl malonate, dimethylpyrazole and phenol.

Additionally, amino resins could be used as crosslinking agents such as melamine-formaldehyde, benzoguanamine-formaldehyde and urea-formaldehyde resins and preferably melamine-formaldehyde resins. They are typically used in a form of etherification with alcohols such as methanol and/or butanol. One example of amino resin is hexamethoxymethylmelamine. Condensation products of other amines and amides may be used and examples are aldehyde condensates of triazines, diazines, triazoles, guanidines, guanimines, and alkyl- and aryl-substituted derivatives of these compounds such as N,N′-dimethylurea, benzourea, dicyandiamide, formaguanamine, acetoguanamine, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 3,4,6-tris(ethylamino)-1,3,5-triazine, tris(alkoxycarbonylamino)triazine. Furthermore, condensation products with other aldehydes can be used in addition to the condensation products with formaldehyde.

Methylol groups of amino resins could be blocked by carbamate or allophanate groups. Crosslinking agents of this kind are described in U.S. Pat. No. 4,710,542A and EP0245700B as well as article of B. Singh et al, i.e. “Carbamylmethylated Melamines, Novel Crosslinkers for the Coatings Industry”, Advanced Organic Coatings Science and Technology Series, 1991, volume 13, pages 193 to 207.

Said amino resins are available in the market, for examples products with brands of Cymel, Luwipal, Maprenal, Resimene, and Beetle, etc.

### Other Components

The coating composition can further comprise other components like pigments, fillers etc. All organic or inorganic type of color and/or special effect pigments could be used in the coating composition. Examples of color pigments are titanium dioxide, micronised titanium dioxide, iron oxide pigments, carbon black, azo pigments, phthalocyanine pigments, quinacridone and pyrrolopyrrole pigments. Examples of special effect pigments are metal pigments such as aluminum or copper, interference pigments such as aluminum coated with titanium dioxide, coated mica, graphite effect pigments. Examples of fillers are silicon dioxide, barium sulphate, talcum, aluminium silicate and magnesium silicate.

Other additives commonly used in coating industry could be added also such as light stabilizer, thickener, anti-foaming agent and wetting agent etc. These additives are added in an amount known to persons skilled in the art.

The coating compositions contain water in an amount of from 10% to 60%, preferably from 15% to 50%, and more preferably from 20% to 40% by weight and may also contain organic solvents in an amount of from 5% to 30%, preferably from 10% to 25%, and preferably from 15% to 20% by weight, based on the total weight of the coating composition. Examples of solvents are monohydric or polyhydric alcohols, e.g. propanol, butanol, hexanol; glycol ethers or esters such as diethylene glycol di-C₁-C₆-alkyl ether, dipropylene glycol di-C₁-C₆-alkyl ether, ethoxypropanol, butyl glycol, butyl glycol acetate, butyl glycol propionate; glycols such as ethylene glycol, propylene glycol, N-methyl pyrrolidone and ketones such as methyl ethyl ketone, acetone, cyclohexanone; aromatic or aliphatic hydrocarbons such as toluene, xylene and aliphatic C₆-C₁₂-hydrocarbons. If organic solvents are present, water-miscible organic solvents are preferred.

The term “solid content” means the weight ratio of residues after evaporation of solvent based on the total weight of the coating composition. The solid content of the coating composition is preferably in a range of from 35% to 85%, more preferably from 45% to 80%, and even more preferably from 50% to 70% by weight measured according to GB24409-2020.

The sagging limit of the coating compositions is from 30 to 75 μm, preferably from 35 to 70 μm, and more preferably from 40 to 65 μm.

The coating composition is prepared by mixing all components using known apparatus such as stirred tanks, agitator mills, extruders, compounders, Ultraturrax, in-line dissolvers, static mixers, toothed-wheel dispersers, pressure relief nozzles and/or microfluidizers, optionally with exclusion of actinic radiation.

The coating composition of the invention is preferably used in automotive finishing or refinishing and applied onto different substrates. Accordingly, a coating layer formed by curing the coating composition is provided as well.

Application of the coating composition onto a substrate can be carried out by all methods known to persons skilled in the art such as spraying, knife coating, spreading, pouring, dipping, impregnating, trickling or rolling. During such application, the substrate shall be at rest while the application device shall be moved. Alternatively, the substrate preferably a coil may also be moved and the application device shall be at rest.

Preferably spraying application is used such as compressed air spraying (pneumatic application systems), airless spraying, high-speed rotation, electrostatic spray application (ESTA), optionally in combination with hot spraying application such as hot air spraying.

The rest time or evaporation time means the gap after application and before curing. During rest time, coating compositions are leveling and volatile solvents inside are evaporating. The rest time may be shortened by elevating temperatures and/or reducing atmospheric humidity provided it will not bring any damage such as incomplete crosslinking.

After rest time is finished, a curing via thermal or NIR (near infrared radiation) of the coating composition could be carried out by methods known to persons skilled in the art such as heating in a forced-air oven or irradiation with IR lamps. The thermal curing is performed at a temperature of from 40° C. to 190° C., preferably from 50° C. to 180° C., and more preferably from 120° C. to 160° C. for from 1 minute to 10 hours, preferably from 2 minutes to 5 hours, more preferably from 3 minutes to 3 hours, and even more preferably from 10 minutes to 0.5 hour. For the two-component coating system, the thermal curing takes place at a temperature of from 80° C. to 160° C. for 20 minutes to 1 hour. And the thermal curing takes place preferably at a temperature of from 100° C. to 160° C. for 20 minutes to 40 minutes for metal substrates while it takes place at a temperature of from 60° C. to 100° C. for 30 minutes to 1 hour for plastic substrates (“low-bake” method).

The coating composition could be applied directly onto the substrate to form a single coating layer or applied onto painting layer adhered to the substrate to form multi-coating layers. The substrate is preferably a metal or plastic, for example those used to produce parts of automotive such as PP (polypropylene)/EPDM (copolymer of ethylene-propylene-diene), polyamide and/or ABS(copolymer of acrylonitrile-butadiene-styrene).

For metal substrates, the coating is applied after electrocoat, primer and basecoat are formed. For plastic substrates, the coating is applicable for both single coating layer and multi-coating layers and when multi-coating layers are selected, the use of primer, base coat, topcoat etc. are known to persons skilled in the art.

### EMBODIMENTS

Below embodiments are used to further illustrate how this invention could be carried out.

### Embodiment 1

A water-borne coating composition comprising
a) at least one water-soluble or water-dispersable binder,
b) at least one sagging control agent (SCA), wherein Component b) is obtained by reaction of
b1) at least one aliphatic polyisocyanate, and
b2) at least one amine selected from a group consisting of C₁-C₁₀-alkoxy-C₁-C₁₀-alkylamine, di-C₁-C₁₀-alkoxy-C₁-C₁₀-alkylamine, C₄-C₁₀-alkyl substituted aniline and di-C₄-C₁₀-alkyl substituted aniline in the presence of Component a).

### Embodiment 2

The water-borne coating composition according to Embodiment 1, wherein it further comprises Component c): at least one crosslinking agent.

### Embodiment 3

The water-borne coating composition according to Embodiment 2, comprising:
from 10% to 90%, preferably from 15% to 70%, and more preferably from 20 to 50% by weight of Component a), from 0.1% to 40%, preferably from 5% to 35%, and more preferably from 15% to 30% by weight of Component b), and from 0.1% to 70%, preferably from 15% to 60%, and more preferably from 30% to 50% by weight of Component c), wherein the weight percentage of Component a), b) and c) are based on the total weight of the water-borne coating composition.

### Embodiment 4

The water-borne coating composition according to any one of Embodiments 1 to 3, wherein Component a) is preferably at least one selected from a group consisting of polyacrylate resins, polyester resins, melamine resins, polyether and polyurethane resins.

### Embodiment 5

The water-borne coating composition according to Embodiment 4, wherein said water-soluble or water-dispersable polyacrylate resin is preferably at least one selected from a group consisting of polymeric organic compounds synthesized from (meth)acrylate excluding hydroxyl functionality, (meth)acrylate having at least one hydroxyl functionality, optionally (meth)acrylic acid and other monomers having at least one olefinic double bond.

### Embodiment 6

The water-borne coating composition according to Embodiment 5, wherein said (meth)acrylate excluding hydroxyl functionality is preferably at least one selected from a group consisting of C₁-C₁₈-alkyl (meth)acrylates and C₃-C₈-cycloalkyl (meth)acrylates, more preferably from a group consisting of C₁-C₁₂-alkyl (meth)acrylates and C₃-C₆-cycloalkyl (meth)acrylates, and even more preferably from a group consisting of C₁-C₆-alkyl (meth)acrylates and C₅-C₆-cycloalkyl (meth)acrylates.

### Embodiment 7

The water-borne coating composition according to Embodiment 5, wherein said (meth)acrylate having at least one hydroxyl functionality is preferably at least one selected from a group consisting of C₁-C₆-hydroxyalkyl (meth)acrylates, and more preferably from a group of C₂-C₄-hydroxyalkyl (meth)acrylates.

### Embodiment 8

The water-borne coating composition according to Embodiment 5, wherein said monomers having at least one olefinic double bond is preferably at least one selected from a group consisting of vinylaromatic hydrocarbons, more preferably from a group consisting of styrene, vinyltoluene and alpha-methylstyrene and even more preferably from a group consisting of styrene, amides, nitriles of acrylic, methacrylic acid, vinyl esters and vinyl ethers.

### Embodiment 9

The water-borne coating composition according to any one of Embodiments 4 to 8, wherein the number-average molecular weight of said polyacrylate resin is from 1,000 to 10,000 g/mol, and preferably from 1,500 to 5,000 g/mol.

### Embodiment 10

The water-borne coating composition according to any one of Embodiments 4 to 9, wherein the weight-average molecular weight of said polyacrylate resin is from 3,000 to 20,000 g/mol, and preferably from 5,000 to 12,000 g/mol.

### Embodiment 11

The water-borne coating composition according to any one of Embodiments 4 to 10, wherein said polyacrylate resin has an acid value of from 10 to 200 mg KOH/g, preferably from 20 to 100 mg KOH/g, and more preferably from 30 to 50 mg KOH/g.

### Embodiment 12

The water-borne coating composition according to any one of Embodiments 4 to 11, wherein said polyacrylate resin has a hydroxyl value of from 50 to 300 mg KOH/g, preferably from 60 to 240 mg KOH/g, and more preferably from 80 to 200 mg KOH/g.

### Embodiment 13

The water-borne coating composition according to any one of Embodiments 2 to 12, wherein said Component c): crosslinking agent is preferably at least one selected from nonblocked, partially blocked and blocked polyisocyanates and amino resins.

### Embodiment 14

The water-borne coating composition according to any one of Embodiments 1 to 13, wherein said b1): aliphatic polyisocyanate is preferably selected from a group consisting of a symmetrical aliphatic diisocyanate and oligomers of symmetrical aliphatic diisocyanate.

### Embodiment 15

The water-borne coating composition according to Embodiment 14, wherein said b1): aliphatic polyisocyanate is preferably at least one selected from a group consisting of tetramethylene-1,4-diisocyanate, hexamethylene-1,6-diisocyanate, octamethylene diisocyanate, decamethylene diisocyanate, dodecamethylene diisocyanate, tetradecamethylene diisocyanate, trimethylhexane diisocyanate and tetramethylhexane diisocyanate, and trimer of hexamethylene-1,6-diisocyanate.

### Embodiment 16

The water-borne coating composition according to any one of Embodiments 1 to 15, wherein said b2): amine is preferably at least one selected from a group consisting of C₁-C₆-alkoxy-C₂-C₆-alkylamine, di-C₁-C₆-alkoxy-C₂-C₆-alkylamine, C₄-C₈-alkyl substituted aniline and di-C₄-C₈-alkyl substituted aniline, and more preferably from a group consisting of C₁-C₄-alkoxy-C₂-C₄-alkylamine and C₄-C₆-alkyl substituted aniline.

### Embodiment 17

The water-borne coating composition according to Embodiment 16, wherein said b2): amine is preferably at least one selected from a group consisting of 2-methoxyethylamine, 2-ethoxyethylamine, 3-methoxy-1-propylamine, 1-methoxybutyl-2-amine, 1,1-dimethoxy-2-propylamine, 3-ethoxy-1-propylamine, 3-butoxy-1-propylamine, 3-(2-ethylhexyloxy)-1-propylamine, 4-n-butyl aniline, 4-sec-butyl aniline, 4-isobutyl aniline, 4-tert-butyl aniline, 4-n-pentyl aniline, 4-isopentyl aniline and 4-n-hexyl aniline, preferably 3-methoxy-1-propylamine, 3-ethoxy-1-propylamine, 3-butoxy-1-propylamine, 4-n-butyl aniline, 4-sec-butyl aniline, 4-isobutyl aniline and 4-tert-butyl aniline, and more preferably from a group consisting of 3-methoxy-1-propylamine, 3-ethoxy-1-propylamine, 4-n-butyl aniline, 4-isobutyl aniline and 4-tert-butyl aniline.

### Embodiment 18

The water-borne coating composition according to any one of Embodiments 1 to 17, wherein the molar ratio of amino groups of b2): amine to isocyanate groups of b1): aliphatic polyisocyanate is in a range of from 0.7 to 1.5, preferably from 0.8 to 1.2, and more preferably from 0.9 to 1.1.

### Embodiment 19

A method of preparing the water-borne coating composition according to any one of Embodiments 1 to 18 by mixing Components a), b) and optionally, c).

### Embodiment 20

A coating layer formed by curing water-borne coating composition according to any one of Embodiments 1 to 18 that is applied onto a substrate.

### EXAMPLES

The following non-limiting examples are included to further illustrate various embodiments of the instant disclosure and do not limit the scope of the instant disclosure.

### Materials Used in all Examples

Desmodur N3300: aliphatic polyisocyanate (HDI trimer), commercially available from Covestro AG
Cymel 327: crosslinking agent, commercially available from Allnex TBN-75PS: crosslinking agent, blocked polyisocyanates, commercially available from Asahi Kasei
Disparlon AQ-7180: wetting agent, commercially available from Kusumoto Chemicals, Ltd.
Tinuvin 400 and Tinuvin 292: light stabilizer, commercially available from BASF

The molecular weights (including weight average and number average molecular weights) of polyacrylates are measured by gel permeation chromatography (GPC):

| Apparatus: | Agilent 1200 series | |
|---|---|---|
| Eluent: | 1 mol/L CH₃COOH—THF | |
| Injector volume: | 100 | μL |
| Temperature: | 35° | C. |
| Flow: | 1.0 | ml/min |
| Running time: | 50 | min |

| | |
|---|---|
| Molecular standard: | PMMA |

The viscosity of SCA is measured by rheometer (Antor paar MCR 302) under shearing rates of 1 s⁻¹ and 1,000 s⁻¹.

### Example 1: Synthesis of Polyacrylate A

In a stainless steel reactor, 173.9 parts by weight of butyl glycol was pre-loaded under atmospheric pressure with nitrogen gas flashing off with a stirring at a speed of 100 RPM (rotation per minute). The reactor was heated to 120° C. and when temperature was stable, the premix of 40.2 parts by weight of tert-butyl peroxy-2-ethylhexanoate and 38.0 parts by weight of butyl glycol was dosed during 4.75 hours. About 15 minutes after the initiator's loading, the premix of 81.5 parts by weight of styrene, 108.7 parts by weight of hydroxyethyl methacrylate, 81.5 parts by weight of tert-butyl acrylate, 81.5 parts by weight of tridecyl methacrylate, 163 parts by weight of cyclohexyl methacrylate, 24.5 parts by weight of acrylic acid and 5.4 parts by weight of butyl glycol was dosed during 4 hours. After the monomer and initiator were dosed, the reactor was kept at 120° C. for 1 hour. The reactor was then cooled to 80° C. and loaded with 11.7 parts by weight of dimethyl ethanolamine within 5 minutes for neutralization. After the reactor was kept at 70° C. for 30 minutes, 190.2 parts by weight of deionized water was loaded through dropping funnel for 1 hour. After 30 minutes' stirring, the synthesized resin was filtrated through steel filter bag in a size of 200 μm. The molecular weight was characterized by GPC, Mw (weight average molecular weight): 9,600, Mn (number average molecular weight): 4,600.

### Example 2: Synthesis of Polyacrylate B

In a stainless steel reactor, 167.6 parts by weight of butyl glycol was pre-loaded under a atmospheric pressure with nitrogen gas flashing off with a stirring at a speed of 100 RPM. The reactor was heated to 120° C. When temperature was stable, the premix of 40.3 parts by weight of tert-butyl peroxy-2-ethylhexanoate and 36.1 parts by weight of butyl glycol was dosed during 4.75 hours. About 15 minutes after the initiator's loading, the premix of 26.2 parts by weight of styrene, 246.2 parts by weight of hydroxyethyl methacrylate, 65 parts by weight of tert-butyl acrylate, 66 parts by weight of tridecyl methacrylate, 131 parts by weight of cyclohexyl methacrylate, 23.6 parts by weight of acrylic acid and 5.2 parts by weight of butyl glycol was dosed during 4 hours. After the monomer and initiator were dosed, the reactor was kept at 120° C. for 1 hour. The reactor was then cooled to 80° C. and loaded with 10 parts by weight of dimethyl ethanolamine within 5 minutes for neutralization. After the reactor was kept at 70° C. for 30 minutes, 194 parts by weight of deionized water was loaded through dropping funnel for 1 hour. After 30 minutes' stirring, the synthesized resin was filtrated through steel filter bag in a size of 200 μm. The molecular weight was characterized by GPC, Mw: 8, 100, Mn: 4, 100.

### Example 3: Synthesis of SCA C

In a stainless steel reactor, 251 parts by weight of polyacrylate A (solids content: 59 wt %) and 4.59 parts by weight of 3-methoxy-1-propylamine were mixed at room temperature (5-40° C.) for 2 mins. Then a premix of 9.75 parts by weight of Desmodur N3300 and 9.11 parts by weight of butyl glycol was added into the reactor under full stirring power of 2,000 RPM for 10 mins. After the addition, the mixture was further stirred for another 10 mins, then the reaction was completed. The obtained SCA C was butter-like solid and its viscosity is not measurable.

### Example 4: Synthesis of SCA D

In a stainless steel reactor, 251 parts by weight of polyacrylate A (solids content: 59 wt %) and 4.61 parts by weight of 3-methoxy-1-propylamine were mixed at room temperature (5-40° C.) for 2 mins. Then a premix of 4.26 parts by weight of HDI monomer and 9.13 parts by weight of butyl glycol was added into the reactor under full stirring power of 2,000 RPM for 10 mins. After the addition, the mixture was further stirred for another 10 mins, then the reaction was completed. The viscosity of obtained SCA D was 17,647 and 686 mpa·s under shearing rates of 1 s⁻¹ and 1,000 s⁻¹ respectively.

### Example 5: Synthesis of SCA E

In a stainless steel reactor, 251 parts by weight of polyacrylate A (solids content: 59 wt %), 3.85 parts by weight of 4-butylaniline and 10.74 parts by weight of butyl glycol were mixed at room temperature (5-40° C.) for 2 mins. Then a premix of 4.83 parts by weight of Desmodur N3300 and 13.46 parts by weight of butyl glycol was added into the reactor under full stirring power of 2,000 RPM for 10 mins. After the addition, the mixture was further stirred for another 10 mins, then the reaction was completed. The viscosity of obtained SCA E was 6,370 and 632 mpa·s under shearing rates of 1 s⁻¹ and 1,000 s⁻¹ respectively.

### Example 6: Synthesis of SCA F

In a stainless steel reactor, 251 parts by weight of polyacrylate A (solids content: 59 wt %) and 7.81 parts by weight of 4-butylaniline were mixed at room temperature (5-40° C.) for 2 mins. Then a premix of 4.33 parts by weight of HDI monomer and 9.27 parts by weight of butyl glycol was added into the reactor under full stirring power of 2,000 RPM for 10 mins. After the addition, the mixture was further stirred for another 10 mins, then the reaction was completed. The viscosity of obtained SCA F was 13, 129 and 1,196 mpa·s under shearing rates of 1 s⁻¹ and 1,000 s⁻¹ respectively.

### Example 7: Synthesis of SCA G (Comparative Example)

In a stainless steel reactor, 251 parts by weight of polyacrylate A (solids content: 59 wt %), 1.58 parts by weight of ethanolamine and 6.6 parts by weight of butyl glycol were mixed at room temperature (5-40° C.) for 2 mins. Then a premix of 4.83 parts by weight of Desmodur N3300 and 20.20 parts by weight of butyl glycol was added into the reactor under full stirring power of 2,000 RPM for 10 mins. After the addition, the mixture was further stirred for another 10 mins, then the reaction was completed. The viscosity of obtained SCA G was 2,952 and 537 mpa·s under shearing rates of 1 s⁻¹ and 1,000 s⁻¹ respectively.

### Example 8: Synthesis of SCA H (Comparative Example)

In a stainless steel reactor, 251 parts by weight of polyacrylate A (solids content: 59 wt %), 3.15 parts by weight of ethanolamine and 0.31 parts by weight of butyl glycol were mixed at room temperature (5-40° C.) for 2 mins. Then a premix of 4.26 parts by weight of HDI monomer and 9.11 parts by weight of butyl glycol was added into the reactor under full stirring power of 2,000 RPM for 10 mins. After the addition, the mixture was further stirred for another 10 mins, then the reaction was completed. The viscosity of obtained SCA H was 2,621 and 1,017 mpa·s under shearing rates of 1 s⁻¹ and 1,000 s⁻¹ respectively.

### Example 9: Synthesis of SCA I (Comparative Example)

In a stainless steel reactor, 251 parts by weight of polyacrylate A (solids content: 59 wt %), 3.54 parts by weight of 4-methoxybenzylamine and 10.51 parts by weight of butyl glycol were mixed at room temperature (5-40° C.) for 2 mins. Then a premix of 4.83 parts by weight of Desmodur N3300 and 20.20 parts by weight of butyl glycol was added into the reactor under full stirring power of 2,000 RPM for 10 mins. After the addition, the mixture was further stirred for another 10 mins, then the reaction was completed. The viscosity of obtained SCA I was 7,440 and 647 mpa·s under shearing rates of 1 s⁻¹ and 1,000 s⁻¹ respectively.

### Example 10: Synthesis of SCA J (Comparative Example)

In a stainless steel reactor, 251 parts by weight of polyacrylate A (solids content: 59 wt %) and 7.07 parts by weight of 4-methoxybenzylamine were mixed at room temperature (5-40° C.) for 2 mins. Then a premix of 4.26 parts by weight of HDI monomer and 9.11 parts by weight of butyl glycol was added into the reactor under full stirring power of 2,000 RPM for 10 mins. After the addition, the mixture was further stirred for another 10 mins, then the reaction was completed. The viscosity of obtained SCA J was 6, 187 and 1,192 mpa·s under shearing rates of 1 s⁻¹ and 1,000 s⁻¹ respectively.

### Sagging Testing of the Water-Borne Coating Compositions

The water-borne coating compositions were prepared by mixing components list in Table 1 under room temperature (5-40° C.) with stirring.

### The Sagging Test was Carried Out According to Following Method:

The coating composition was sprayed by pneumatic spray onto a steel panel (size: 60 cm×30 cm) covered with electrical deposited coatings (thickness: 15 μm, CG 800 from BASF coatings) to form a layer of clearcoat with gradient thickness. The sprayed panel was cured in an oven hanging vertically under 140° C. for 20 minutes. After curing was finished, the thickness of panel was measured on the position where the sagging happens and the thickness of panel in this position was recorded as sagging value. The sagging test results of examples are summarized in Table 1.

TABLE 1

| | Examples | | | | Comparative Examples | | | |
|---|---|---|---|---|---|---|---|---|
| | 1 | 2 | 3 | 4 | 5 | 6 | 7 | 8 |
| | SCA C | SCA D | SCA E | SCA F | SCA G | SCA H | SCA I | SCA J |
| Components(wt %) | MPA + Trimer | MPA + HDI | BLA + Trimer | BLA + HDI | EA + Trimer | EA + HDI | MBA + Trimer | MBA + HDI |
| Polyacrylate A | 10.83 | 10.83 | 10.83 | 10.83 | 10.83 | 10.83 | 10.83 | 10.83 |
| (solids content: 59 wt. %) | | | | | | | | |
| Polyacrylate B | 10.83 | 10.83 | 10.83 | 10.83 | 10.83 | 10.83 | 10.83 | 10.83 |
| (solids content: 59 wt. %) | | | | | | | | |
| SCA resin C | 25.27 | — | — | — | — | — | — | — |
| (solids content: 61 wt. %) | | | | | | | | |
| SCA resin D | — | 25.27 | — | — | — | — | — | — |
| (solids content: 58 wt. %) | | | | | | | | |
| SCA resin E | — | — | 25.27 | — | — | — | — | — |
| (solids content: 59 wt. %) | | | | | | | | |
| SCA resin F | — | — | — | 25.27 | — | — | — | — |
| (solids content: 60 wt. %) | | | | | | | | |
| SCA resin G | — | — | — | — | 25.27 | — | — | — |
| (solids content: 60 wt. %) | | | | | | | | |
| SCA resin H | — | — | — | — | — | 25.27 | — | — |
| (solids content: 61 wt. %) | | | | | | | | |
| SCA resin I | — | — | — | — | — | — | 25.27 | — |
| (solids content: 61 wt. %) | | | | | | | | |
| SCA resin J | — | — | — | — | — | — | — | 25.27 |
| (solids content: 59 wt. %) | | | | | | | | |
| Cymel 327 | 26.71 | 26.71 | 26.71 | 26.71 | 26.71 | 26.71 | 26.71 | 26.71 |
| TBN-75PS | 2.89 | 2.89 | 2.89 | 2.89 | 2.89 | 2.89 | 2.89 | 2.89 |
| H₂O | 10.11 | 10.11 | 10.11 | 10.11 | 10.11 | 10.11 | 10.11 | 10.11 |
| butyl glycol | 9.39 | 9.39 | 9.39 | 9.39 | 9.39 | 9.39 | 9.39 | 9.39 |
| butyl glycol acetate | 2.17 | 2.17 | 2.17 | 2.17 | 2.17 | 2.17 | 2.17 | 2.17 |
| Tinuvin 292 | 0.72 | 0.72 | 0.72 | 0.72 | 0.72 | 0.72 | 0.72 | 0.72 |
| Tinuvin 400 | 0.72 | 0.72 | 0.72 | 0.72 | 0.72 | 0.72 | 0.72 | 0.72 |
| Disparlon 7180 | 0.36 | 0.36 | 0.36 | 0.36 | 0.36 | 0.36 | 0.36 | 0.36 |
| Total | 100.00 | 100.00 | 100.00 | 100.00 | 100.00 | 100.00 | 100.00 | 100.00 |
| Sagging Value | 42 | 59 | 60 | 42 | 21 | No | 30 | No |
| | | | | | | rheological | | rheological |
| | | | | | | effect | | effect |

MPA: 3-methoxy-1-propylamine; BLA: 4-butylaniline; MBA: 4-methoxybenzylamine; EA: ethanolamine
Trimer: Desmodur N3300; HDI: HDI monomer

As shown in Table 1, increased sagging values have been obtained by using the water-borne coating compositions according to the inventive Examples, compared with those according to Comparative Examples. The larger the sagging value is, the coating compositions perform less tendency of sagging.

1. A water-borne coating composition comprising
a) at least one water-soluble or water-dispersable binder, and
b) at least one sagging control agent (SCA),
wherein Component b) is obtained by reaction of
b1) at least one aliphatic polyisocyanate, and
b2) at least one amine selected from the group consisting of C₁-C₁₀-alkoxy-C₁-C₁₀-alkylamine, di-C₁-C₁₀-alkoxy-C₁-C₁₀-alkylamine, C₄-C₁₀-alkyl substituted aniline and di-C₄-C₁₀-alkyl substituted aniline,
in the presence of Component a).

2. The water-borne coating composition according to claim 1, wherein it further comprises Component c) wherein the Component c) is at least one crosslinking agent.

3. The water-borne coating composition according to claim 2, comprising:
from 10% to 90% by weight of Component a),
from 0.1% to 40% by weight of Component b), and
from 0.1% to 70% by weight of Component c),
wherein the weight percentages of Components a), b) and c) are based on the total weight of the water-borne coating composition.

4. The water-borne coating composition according to claim 1, wherein Component a) is at least one selected from the group consisting of polyacrylate resins, polyester resins, melamine resins, polyethers and polyurethane resins.

5. The water-borne coating composition according to claim 4, wherein
said water-soluble or water-dispersable polyacrylate resin is at least one selected from the group consisting of polymeric organic compounds synthesized from (meth)acrylate excluding hydroxyl functionality, (meth)acrylate having at least one hydroxyl functionality, optionally (meth)acrylic acid and other monomers having at least one olefinic double bond.

6. The water-borne coating composition according to claim 5, wherein
said (meth)acrylate excluding hydroxyl functionality is at least one selected from the group consisting of C₁-C₁₈-alkyl (meth)acrylates and C₃-C₈-cycloalkyl (meth)acrylates.

7. The water-borne coating composition according to claim 5, wherein
said (meth)acrylate having at least one hydroxyl functionality is at least one selected from the group consisting of C₁-C₆-hydroxyalkyl (meth)acrylates.

8. The water-borne coating composition according to claim 5, wherein
said monomers having at least one olefinic double bond are at least one selected from the group consisting of vinylaromatic hydrocarbons.

9. The water-borne coating composition according to claim 4, wherein the number-average molecular weight of said polyacrylate resin is from 1,000 to 10,000 g/mol.

10. The water-borne coating composition according to claim 4, wherein the weight-average molecular weight of said polyacrylate resin is from 3,000 to 20,000 g/mol.

11. The water-borne coating composition according to claim 4, wherein said polyacrylate resin has an acid value of from 10 to 200 mg KOH/g.

12. The water-borne coating composition according to claim 4, wherein said polyacrylate resin has a hydroxyl value of from 50 to 300 mg KOH/g.

13. The water-borne coating composition according to claim 2, wherein said Component c) is at least one selected from the group consisting of nonblocked, partially blocked and blocked polyisocyanates and amino resins.

14. The water-borne coating composition according to claim 1, wherein said b1): aliphatic polyisocyanate is selected from the group consisting of a symmetrical aliphatic diisocyanate and oligomers of symmetrical aliphatic diisocyanate.

15. The water-borne coating composition according to claim 14, wherein
said b1): aliphatic polyisocyanate is at least one selected from the group consisting of tetramethylene-1,4-diisocyanate, hexamethylene-1,6-diisocyanate, octamethylene diisocyanate, decamethylene diisocyanate, dodecamethylene diisocyanate, tetradecamethylene diisocyanate, trimethylhexane diisocyanate and tetramethylhexane diisocyanate, and trimer of hexamethylene-1,6-diisocyanate.

16. The water-borne coating composition according to claim 1, wherein said b2): amine is at least one selected from the group consisting of C₁-C₆-alkoxy-C₂-C₆-alkylamine, di-C₁-C₆-alkoxy-C₂-C₆-alkylamine, C₄-C₈-alkyl substituted aniline and di-C₄-C₈-alkyl substituted aniline.

17. The water-borne coating composition according to claim 16, wherein
said b2): amine is at least one selected from the group consisting of 2-methoxyethylamine, 2-ethoxyethylamine, 3-methoxy-1-propylamine, 1-methoxybutyl-2-amine, 1,1-dimethoxy-2-propylamine, 3-ethoxy-1-propylamine, 3-butoxy-1-propylamine, 3-(2-ethylhexyloxy)-1-propylamine, 4-n-butyl aniline, 4-sec-butyl aniline, 4-isobutyl aniline, 4-tert-butyl aniline, 4-n-pentyl aniline, 4-isopentyl aniline and 4-n-hexyl aniline.

18. The water-borne coating composition according to claim 1, wherein the molar ratio of amino groups of b2): amine to isocyanate groups of b1): aliphatic polyisocyanate is in a range of from 0.7 to 1.5.

19. A method of preparing the water-borne coating composition according to claim 1 by mixing Components a), b) and optionally, c).

20. A coating layer formed by curing water-borne coating composition according to claim 1 that is applied onto a substrate.
